(19) United States
(12) Patent Application Publication
(10) Pub. No.: US 2001/0051508 A1
(43) Pub. Date: Dec. 13, 2001

(54) Optical magnifying device for a cellular phone

(76) Inventor: Hsu-Pang Wang, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/870,669

(22) Filed: Jun. 1, 2001

(30) Foreign Application Priority Data
Jun. 13, 2000 (CN) 002392089

(51) Int. Cl. H04B 1/38

(52) U.S. Cl. 455/90; 455/550; 455/344; 455/347

(57) ABSTRACT

An optical magnifying device includes a frame which is connected to a cellular phone and a magnifying plate is connected to the frame. The frame is able to be slid or pivoted relative to the body of the cellular phone so that the magnifying plate is moved to the buttons or the screen of the cellular phone.

### FIELD OF THE INVENTION

The present invention relates to an optical magnifying device connected to a cellular phone so as to magnify words, numbers or patterns on the panel or in the screen of the cellular phone.

### BACKGROUND OF THE INVENTION

Conventional cellular phones provide very much convenience for users to communicate with each other regardless of where they are. In order to let the users to carry and/or store the cellular phone, the conventional cellular phones are made to be compact and light in weight. However, the area panel of the cellular phones becomes smaller and there are still a lot of buttons on the panel so that each button is reduced in its size. The buttons are so small that the users have to identify them carefully, this is especially difficult for the users who have optical problems. Besides, the area of the screen on the panel is reduced either. Many kinds of information are illustrated on the screen and include words, patterns and numbers so that the shrunk screen cannot meet requirements of the users.

The present invention intends to provide an optical magnifying device which is movably or pivotally connected to the cellular phone and is able to magnify words on the panel or on the screen so that the users can easily identify the information on the panel.

### SUMMARY OF THE INVENTION

In accordance with one aspect of the present invention, there is provided an optical magnifying device for a cellular phone and comprising a frame which is pivotably mounted to the body of the cellular phone. A magnifying plate is connected to the frame and the magnifying plate is moved above the screen or buttons of the cellular phone.

The primary object of the present invention is to provide an optical magnifying device for a cellular phone and the magnifying device can be slid or pivoted to a position to magnify the numbers on the buttons or the screen of the cellular phone.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show a cellular phone with an optical magnifying device of the present invention;

FIG. 2 is an exploded view to show the optical magnifying device of the present invention;

FIG. 3 is a cross sectional view to show an embodiment of the optical magnifying device used on a button of a cellular phone;

FIG. 4 is a perspective view to show another embodiment of the optical magnifying device of the present invention;

FIG. 5 is a perspective view to show the optical magnifying device as shown in FIG. 4 and which is slid away from the cellular phone;

FIG. 6 is an exploded view to show yet another embodiment of the optical magnifying device of the present invention;

FIG. 7 is a perspective view to show yet another embodiment of the optical magnifying device of the present invention, and

FIG. 8 is a perspective view to show the optical magnifying device illustrated in FIG. 7 and which is pivoted to an upright position.

### DETAILED DESCRIPTION OF THE PREFERRED EMBODIMENTS

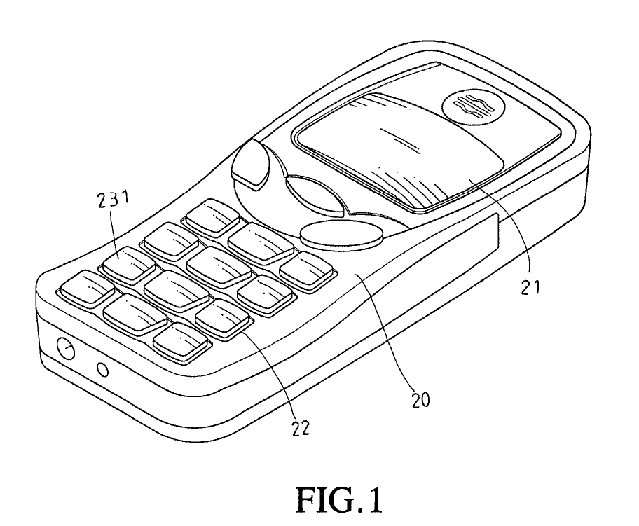

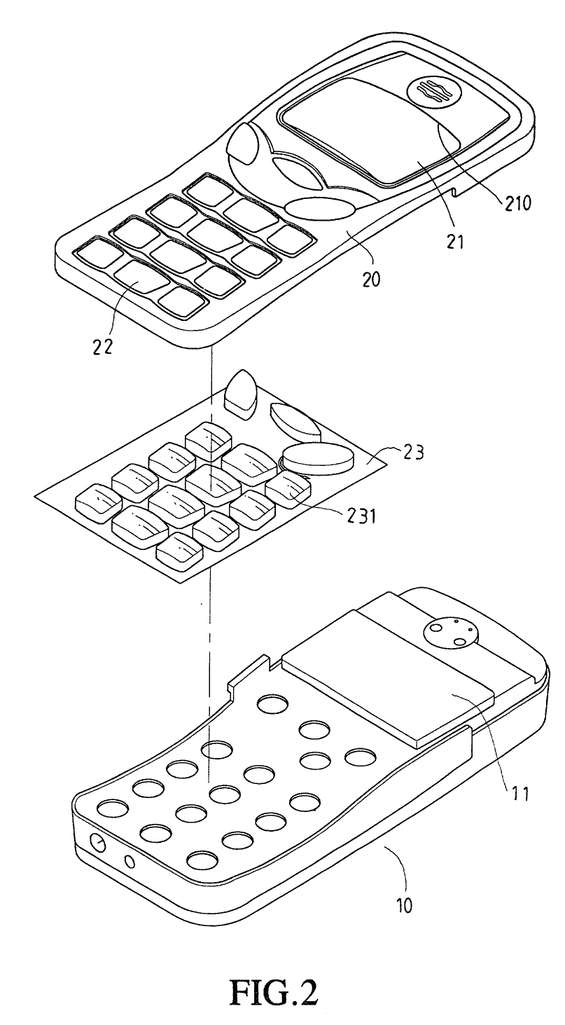

Referring to FIGS. 1 and 2, a cellular phone includes a body 10 with a screen 11 connected thereto and a button panel 23 with buttons 231 on the button panel 23. The button panel 23 is connected to the body 10. A panel cover 20 is mounted to the body 10 and the panel cover 20 having an aperture 210 and holes 221 respectively defined therethrough. The screen 11 on the body 10 is enclosed by a periphery of the aperture 210 and the buttons 231 extend through the holes 221. The optical magnifying device of the present invention includes a magnifying plate 210 engaged with the aperture 210 of the panel cover 20 so that the information displayed on the screen 11 can be magnified via the magnifying plate 210.

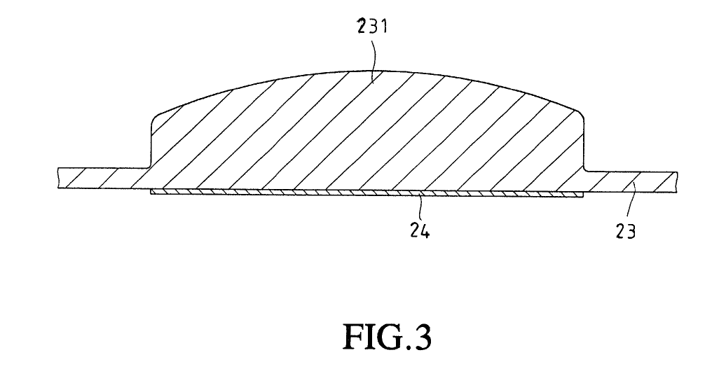

As shown in FIG. 3, the optical magnifying device may be made for the buttons 231 wherein the button 231 is made to have a convex top surface and a pattern sheet 24 is connected to an underside of each button 231. The button 231 is made of transparent material so that the words or numbers on the pattern sheet 24 can be seen and magnified when viewed through the convex top surface of the button 231. Therefore, the buttons 231 can be identified easily. Of course, the way to put a number, a word or a pattern in the button 231 can be done by many known methods such as printing or heat transferring.

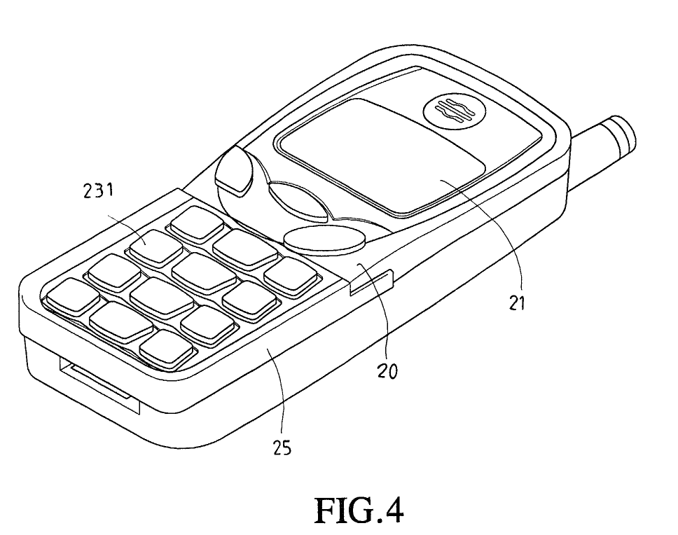

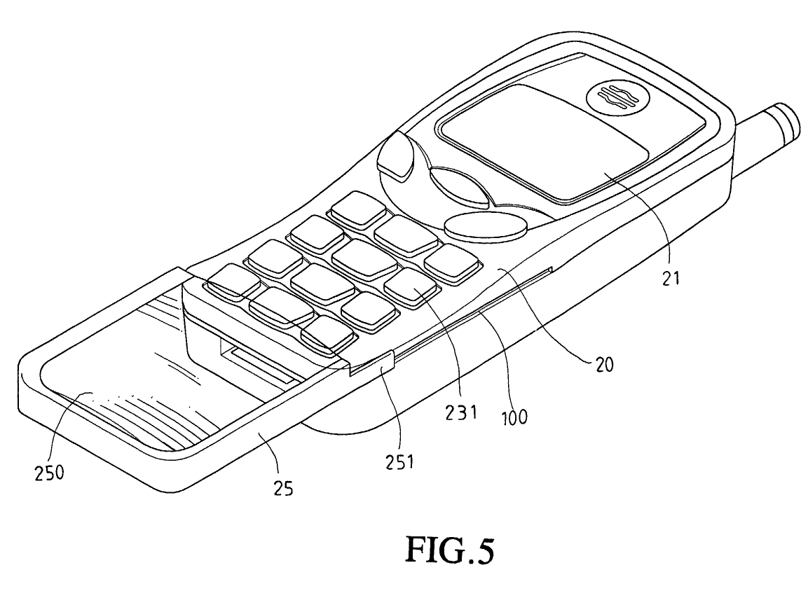

FIGS. 4 and 5 show another embodiment of the present invention wherein the optical magnifying device includes a frame 25 which is a U-shaped frame and includes two legs 251. The two legs 251 are respectively and slidably mounted to two grooves 100 in two sides of the body 10. A magnifying plate 250 is connected to the frame 25 so that the magnifying plate 250 is mounted above the panel cover 20. When the magnifying plate 250 is located above the buttons 231, the numbers on the buttons 231 are magnified.

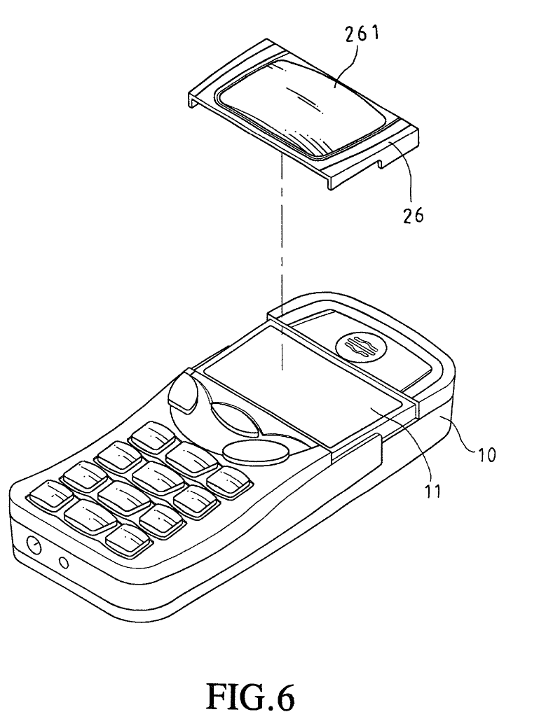

FIG. 6 shows a signal frame 26 with a magnifying plate 261 can be mounted to the screen 11 on the body 10 of the cellular phone to magnify the screen 11.

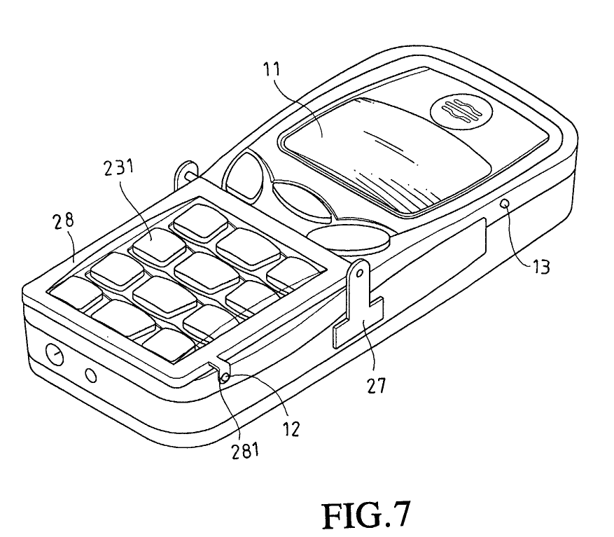

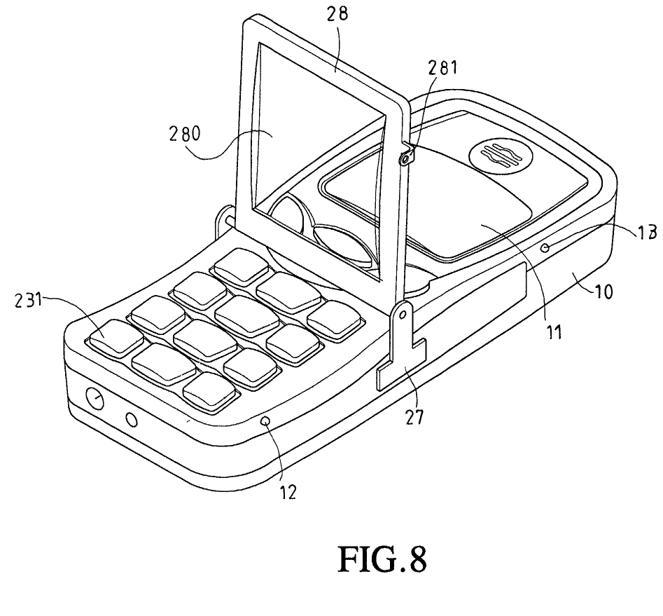

Referring to FIGS. 7 and 8, another embodiment of the optical magnifying device is a rectangular frame 28 and a magnifying plate 280 is connected to the frame 28. The body 10 of the cellular phone has tow protrusions 12, 13 respectively extend from a side of the body 10. Two support members 27 are connected to two sides of the body 10 of the cellular phone so that the frame 28 is pivotally connected between the two support members 27. The frame 28 has a locking member 281 on a side of the frame 28 and the locking member has a hole defined therethrough which receives one of the two protrusions 12, 13. The two positions of the frame 28 allow the user to see clearly the buttons 231 and the screen 11.

While we have shown and described various embodiments in accordance with the present invention, it should be clear to those skilled in the art that further embodiments may be made without departing from the scope and spirit of the present invention.

What is claimed is:

1. An optical magnifying device for a cellular phone which includes a body with a screen connected thereto, a button panel with buttons on the button panel, and a panel cover mounted to the body, the panel cover having an aperture and holes, the screen on the body enclosed by a periphery of the aperture and the buttons extending through the holes, said optical magnifying device comprising:
a magnifying plate adapted to be engaged with the aperture of the panel cover.

2. A cellular phone comprising:
a body with a screen connected thereto and a button panel having buttons on said button panel, and a panel cover mounted to said body, said panel cover having an aperture and holes, said screen on said body enclosed by a periphery of said aperture and said buttons extending through said holes, each button having a convex top surface and a pattern sheet connected to an underside of each button.

3. An optical magnifying device for a cellular phone which includes a body with a screen connected thereto, a button panel with buttons on the button panel, and a panel cover mounted to the body, the panel cover having an aperture and holes, the screen on the body enclosed by a periphery of the aperture and the buttons extending through the holes, said optical magnifying device comprising:
a frame adapted to be slidably mounted to said body and a magnifying plate connected to said frame, said magnifying plate adapted to be mounted above the panel cover.

4. A cellular phone comprising:
a body with a screen connected thereto, a button panel with buttons on said button panel, a panel cover mounted to said body and said button panel connected between said body and said panel cover, said panel cover having an aperture and holes, said screen on said body being enclosed by a periphery of said aperture and said buttons extending through said holes, and
a frame pivotably mounted to said body and a magnifying plate connected to said frame, said magnifying plate located above said panel cover when said frame is pivoted toward said body.

5. The cellular phone as claimed in claim 4 wherein said frame has two legs extending therefrom and said two legs are pivotally connected two sides of said body.

6. The cellular phone as claimed in claim 4 further comprising two protrusions extending from one of two sides of said body and said frame having a locking member extending therefrom, said locking member engaged with one of said two protrusions.

7. The cellular phone as claimed in claim 6 wherein said locking member has a hole defined therethrough which receives one of said two protrusions.
